(19) United States
(12) Patent Application Publication
(10) Pub. No.: US 2016/0072288 A1
(43) Pub. Date: Mar. 10, 2016

(54) GRID TIED, REAL TIME ADAPTIVE, DISTRIBUTED INTERMITTENT POWER

(71) Applicants: CHRISTOPHER ROBERT DEBONE, AIEA, HI (US); STEVEN PETER GODMERE, MILILANI, HI (US)

(72) Inventors: CHRISTOPHER ROBERT DEBONE, AIEA, HI (US); STEVEN PETER GODMERE, MILILANI, HI (US)

(21) Appl. No.: 14/796,987

(22) Filed: Jul. 10, 2015

Related U.S. Application Data
(60) Provisional application No. 62/047,590, filed on Sep. 8, 2014.
(60) Provisional application No. 62/130,589, filed on Mar. 9, 2015.

(51) Int. Cl. H02J 3/14; G05B 15/02

(52) U.S. Cl. CPC H02J 3/14; G05B 15/02

(57) ABSTRACT

Utility (or other grid participant's) customers' intermittent power generation systems and loads (including optional energy storage) are made autonomously real time adaptive at the customer circuit level, so each of the customers' circuits (after powering that customer's varying load) contributes, at that customer's common connection to the utility meter, to the utility's (or other grid participant's) desired outcome for that customer's circuit, or contributes, at the intermediate circuit level, to the utility's desired aggregate outcomes for customers on that intermediate circuit. Energy management controllers are connected, behind the customer's utility meter on the customer's circuit, to controlled load portions of that customer's varying load, to autonomously add or shed, in real time, those controlled load portions, or (if there is stored energy) to autonomously discharge, in real time, stored power from storage. Utility (or other grid participant) rules for achieving desired outcomes can be downloaded to the controllers and customers can individually opt-in to some, all, or none, of those utility (or other grid participant) rules. Real time means within sub second to fifteen second intervals.

This application claims the priority of U.S. provisional patent application No. 62/047,590 filed Sep. 8, 2014, and U.S. provisional patent application No. 62/130,589 filed Mar. 9, 2015.

### TECHNICAL FIELD

The present invention generally relates to the management of grid-tied intermittent power (unpredictable and fluctuating amounts of power) from intermittent power generation systems (preferably power generation systems that convert renewable energy sources, including the sun, wind, waves and others into electrical energy) tied to an electric utility grid (utility grid or grid). More specifically, the invention relates to methods and devices for making customers' intermittent power generation systems and loads (including optional storage) behind the utility meter autonomously real time adaptive at the customer circuit level according to certain rules that are opted in to by the customers.

### BACKGROUND ART

The means of supplying power to customers has changed drastically over the years. Early grid systems used local power generators to supply small networks with a single voltage. Advancements in transformer technology unlocked voltage flexibility and economies of scale to allow power plants to grow and move further away from customers. Recently, there has been a dramatic increase in new and innovative grid participants (public, private and other entities that directly or indirectly generate energy, store energy, distribute energy, manage energy, aggregate energy, collect and provide information on energy, and/or perform any other energy related function or functions in front of customers' utility meters). Grid participants include, but are not limited to traditional electric utilities, energy generators, energy distributors, energy aggregators, and energy management companies.

Further, intermittent power generation systems (which preferably convert renewable energy sources, including the sun, wind, waves and others into electrical energy) have become popular as the price of oil and other conventional energy sources has increased. They are versatile and can be used at public or private properties, including residential, commercial or industrial properties. However, they can cause unpredictable rapid fluctuations in electrical power generation (surges and lulls) due to unpredictable rapid fluctuations in environmental conditions, such as moving clouds, erratic changes in wind speed and direction, and changes in wave height and wave span. Unlike randomly dispersed electrical loads that are in aggregate, similar and predictable across significant regions of a grid, intermittent power generation systems (such as photovoltaic (PV) wind, and other renewable energy systems) introduce wide ranging and instantly changing instabilities on localized segments of a grid, especially in areas where the grid is close to being saturated with connected intermittent power generation systems. Some utilities now restrict or even forbid additional connections of intermittent power generation systems to grid portions with high levels of existing connected intermittent power generation systems that are already saturated with power.

Of course, customers can go completely “off-grid” by using intermittent power generation systems that are not connected to the grid, together with energy storage devices (batteries) to store and discharge all the intermittent power produced from these stand-alone systems; however, these stand-alone systems require batteries with large amounts of storage capacity, making them very expensive.

One solution to the problem of intermittent power related instabilities has been to reject intermittent power from grid-tied intermittent power generation systems during certain times of the day, sending it instead to energy storage devices, or to curtail the intermittent power generation systems during certain times of the day altogether.

Still another solution has been to give a utility centralized control over energy management controllers connected to customer circuits behind the utility meter to perform load shedding (decreasing load), load adding (increasing load), energy storage and energy export, as necessary, to manage the amount of energy exported to the grid from intermittent power generation systems. However, because of unpredictable and instantly changing intermittent power output on localized segments of a grid, customers' resistance to centralized utility control, communication delays between the controllers and the utility over distance, and other reasons, this is not a commercially viable solution.

The following patents and patent applications may be relevant to the field of the invention:

U.S. Pat. No. 8,855,829 B2 to Golden et al., incorporated herein by reference, discloses a system and method for managing power consumption and storage in a power grid. Measurements are received from a plurality of geographically distributed energy management controllers. Each energy management controller has energy storage units with stored energy. The measurements comprise the energy production and storage capacity of the energy management controllers and their associated energy storage units. The measurements are processed, for example aggregated and displayed on a graphical user interface. Commands are transmitted to a first subset of the energy management controllers to command the units to discharge their stored energy into a power grid through an inverter. Commands are transmitted to a second subset of the plurality of energy management controllers to store energy in each unit's energy storage unit.

U.S. Pat. No. 8,552,590 B2 to Moon et al., incorporated herein by reference, discloses an energy management system, including: a first interface configured to receive a first power from a power generation system; a second interface configured to couple to the power generation system, a power grid, and a storage device, and to receive at least one of the first power from the power generation system, a second power from the power grid, or a third power from the storage device, and to supply a fourth power to at least one of the power grid or a load; and a third interface configured to receive the third power from the storage device, and to supply as fifth power to the storage device for storage.

U.S. Patent Application Publication No. US 20130162215 A1 to Cooper, incorporated herein by reference, discloses a method of managing the consumption and distribution of electricity in a user facility, wherein the user facility is connected to an electricity supply grid and the user facility comprises a grid connected to an onsite generator; the method comprising the steps of measuring waveform conditions on a portion of the electricity supply grid adjacent the user facility to obtain locally measured waveform conditions; measuring electrical power readings from the on-site generator; communicating the locally measured waveform conditions and the electrical power readings to a controller in the user facility; determining, at least on the basis of the locally measured waveform conditions, whether the electricity supply grid is oversupplied or undersupplied with electricity; and, modifying the flow of the electricity within the user facility based on whether the electricity supply grid is oversupplied or undersupplied with electricity and/or the electrical power readings from the grid connected on site generator.

U.S. Pat. No. 8,558,991 B1 to Forbes, Jr., incorporated herein by reference, discloses systems, methods, and apparatus embodiments for electric power grid and network registration and management of active grid elements. Grid elements are transformed into active grid elements following initial registration of each grid element with the system, preferably through network-based communication between the grid elements and a coordinator, either in coordination with or outside of an IP-based communications network router. A multiplicity of active grid elements function in the grid for supply capacity, supply and/or load curtailment as supply or capacity. Also preferably, messaging is managed through a network by a Coordinator using IP messaging for communication with the grid elements, with the energy management system (EMS), and with the utilities, market participants, and/or grid operators.

U.S. Patent Application Publication No. US 20140018969 A1 to Joseph W. Forbes, Jr., incorporated herein by reference, discloses systems and methods for managing power supplied over an electric power grid by an electric utility and/or other market participants to a multiplicity of grid elements and devices for supply and/or load curtailment as supply, each of which having a Power Supply Value (PSV) associated with its energy consumption and/or reduction in consumption and/or supply, and wherein messaging is managed through a network by a Coordinator using IP messaging for communication with the grid elements and devices, with the energy management system (EMS), and with the utilities, market participants, and/or grid operators.

U.S. Pat. No. 8,457,802 B1 to Steven et al., incorporated herein by reference, discloses assisting customers in managing the four types of energy assets, that is, generation, storage, usage, and controllable load assets. Embodiments of the present invention for the first time develop and predict a customer baseline (“CBL”) usage of electricity, using a predictive model based on simulation of energy assets, based on business as usual (“BAU”) of the customer's facility. The customer is provided with options for operating schedules based on algorithms, which allow the customer to maximize the economic return on its generation assets, its storage assets, and its load control assets. Embodiments of the invention enable the grid to verify that the customer has taken action to control load in response to price. This embodiment of the invention calculates the amount of energy that the customer would have consumed, absent any reduction of use made in response to price. Specifically, the embodiment models the usage of all the customer's electricity consuming devices, based on the customer's usual conditions. This model of the expected consumption can then be compared to actual actions taken by the customer, and the resulting consumption levels, to verify that the customer has reduced consumption and is entitled to payment for the energy that was not consumed.

U.S. Patent Application Publication No. US 2011/0093127 A1 to Kaplan et al, incorporated herein by reference, discloses a Distributed Energy Resources Manager to connect electrical assets in an electricity distribution grid with other information-processing systems including, but not limited to, existing utility grid management systems to manage flows of information between electrical assets and interacting software assets and, thereby, manage performance of at least the electrical assets.

### DISCLOSURE OF THE INVENTION

The present invention relates to methods and devices for enabling power generation customers to make their intermittent power generation systems (preferably photovoltaic (PV), wind, and other renewable energy systems), loads, and optional energy storage autonomously real time adaptive at the customer circuit level by connecting energy management controllers (controllers), behind a customer's utility meter on the customer's circuit, to the customer's charger/inverter (which is connected directly or indirectly to the customer's power generation system and optional storage device) and to controlled load portions of that customer's varying load, to autonomously direct, in real time, generated power to storage or to that customer's controlled load, or to autonomously discharge, in real time, stored power from storage, or to autonomously shed, in real time, portions of that customer's controlled load, to meet (after powering that customer's varying load) a grid participant's or customer's desired outcome for that customer's circuit. The controllers are preferably downloadably connected directly or indirectly to the grid participant. The charger/inverter in the present invention would only be an inverter if there was no storage device.

For purposes of this disclosure, a “grid participant” is preferably any public, private or other entity that directly or indirectly generates energy, stores energy, distributes energy, manages energy, aggregates energy, collects and provides information on energy, and/or performs any other similar function or functions in front of customers' utility meters, and includes, but is not limited to, traditional electric utilities, energy generators, energy distributors, energy aggregators, and energy management companies. Further, a “utility grid” or “grid” is a network of connections to provide power to multiple customers, which may or may not include a centralized power source, such as a utility.

The energy management controllers of the present invention can be implemented in any manner known to a person of ordinary skill in the art, including software implemented on a computer. They can also be configured in several different ways, including but not limited to energy management controllers for each device or load being controlled (for example, controlled loads, critical loads or other loads, including storage devices and charger/inverters), or as a single energy management controller for a customer circuit that remotely controls controllable switches at each device or load being controlled (for example, controlled loads, critical loads or other loads, including storage devices and charger/inverters).

Moreover, each energy management controller preferably acts autonomously from the grid participant and also autonomously from each other. No two controllers experience the same conditions and/or fluctuations in intermittent power generation and varying loads on their customer circuits so each can preferably react and adapt autonomously in real time to its unique circumstances.

Preferably, the grid participant can periodically update and download selected grid participant parameters (rules) to the controllers for achieving the grid participant's desired outcome for that customer's circuit, the grid participant's desired aggregate outcomes for all customers on an intermediate circuit, or the grid participant's desired aggregate outcome for the grid, but customers elect the degree to which to enable real-time adaptiveness of their customer circuits to achieve the grid participant's desired outcomes, by opting in to all, some, or none of the rules. The energy management controllers are optionally controllable directly by the customer, or by a separate customer computer with a user interface (connected to the customers' energy management controllers), through which a customer can opt in to all, some or none of the grid participant rules. Further, the energy management controllers can optionally forego making customers intermittent power generation systems and loads (including optional energy storage) real-time adaptive at the customer circuit level, and accept and act according to grid participant rules that require centralized control by the energy grid participant at times defined and established by the energy grid participant.

For purposes of this disclosure, an “intermediate circuit” can be any circuit between the customer circuit and the grid participant, including without limitation transformers, neighborhood circuits, substations, and sub-transmission substations. Further, practically, “real time” means within fifteen seconds, preferably it means within 10 seconds, and optimally it means within one second or less.

The present invention is preferably a first method for managing load on a grid operably attached to a grid participant that provides power to customers through a plurality of intermediate circuits, wherein each customer has a varying load on a customer circuit that is behind a utility meter connected at a common connection to one of the intermediate circuits, preferably comprising: providing energy management controllers (or controllers) to controlled load customers to enable each controlled load customer to controllably switch in real time selectable controlled load portions of the varying load of that controlled load customer, by connecting or disconnecting the controlled load portions from the customer circuit in real time, whereby the controller allows shedding of load shedding parts, and adding of load adding parts, of the controlled load portions of that controlled load customer in real time behind the utility meter; wherein the controllers for each controlled load customer are preferably downloadably connected to the grid participant so that the grid participant can download to the controllers grid participant rules for achieving the grid participant's desired outcome for the intermediate circuit of that controlled load customer; wherein certain of the controlled load customers are preferably power generation customers, who each has an intermittent power generation system that provides unpredictably fluctuating generated power to that power generation customer's customer circuit; preferably detecting in real time changes in each power generation customer's varying load and unpredictably fluctuating generated power; wherein, in real time response to detected excesses in power to meet a power generation customer's varying load and desired outcome on that power generation customer's customer circuit, the controllers for that power generation customer's customer circuit preferably autonomously connect the power generation customer's intermittent power generation system to the load adding parts to add sufficient load in real time to absorb the excesses behind the utility meter; wherein, in real time response to detected deficiencies in power to meet the power generation customer's varying load and desired outcome on that power generation customer's customer circuit, the controllers for that power generation customer's customer circuit preferably autonomously disconnect the load shedding parts to shed sufficient load in real time to reduce the deficiencies behind the utility meter; whereby autonomously connecting and disconnecting the load adding parts and the load shedding parts behind the meter in real time according to the grid participant rules preferably contributes to making the power generation customers' customer circuits autonomously real time adaptive to conform to the grid participant rules.

The controllers for each controlled load customer are preferably associated with reference criteria for that controlled load customer. Preferably, the first method further comprises downloading the grid participant rules to at least a referenced subset of controllers selected by the reference criteria that can preferably autonomously manage in real time the controlled loads of referenced a controlled load customers; wherein each of the referenced controlled load customers can preferably individually elect whether to opt-in to a particular grid participant rule, whereby referenced controlled load customers who have decided to opt-in to the particular grid participant rule are opted-in, customers for the particular grid participant rule; whereby autonomous load shedding and load adding of the load shedding parts and the load adding parts in real time behind the utility meter preferably controls the opted-in customers loads in real time according to the particular and participant rule to preferably contribute to making the intermediate circuits for the referenced controlled load customers autonomously real time adaptive to substantially conform to the particular grid participant rule.

Preferably, the controlled load portions of controlled load customers include energy storage.

The present invention is also preferably a second method for managing load on a grid operably connected to a grid participant that provides power to customers through a plurality of intermediate circuits, wherein each customer has a varying load on a customer circuit that is behind a utility meter connected at a common connection to one of the intermediate circuits, comprising: controllably connecting energy management controllers to controlled load portions of the varying loads of controlled load customers, to preferably control the controlled load portions in real time, by autonomously connecting or disconnecting the controlled load portions from the customer circuits of the controlled load customers in real time, whereby the controllers preferably allow autonomous load shedding and load adding of the controlled load portions in real time behind the utility meter; wherein the controllers are preferably associated with reference criteria for each controlled load customer; wherein the controllers are preferably downloadably connected to the grid participant so that the grid participant can download grid participant rules to the controllers; downloading the grid participant rules to at least a referenced subset of controllers selected by the reference criteria that can preferably autonomously manage in real time the controlled loads of referenced controlled load customers; wherein each of the referenced controlled load customers can preferably individually elect whether to opt-in to a particular grid participant rule, whereby referenced controlled load customers who have decided to opt-in to the particular grid participant rule are preferably opted-in customers for the particular grid participant rule; whereby autonomous shedding of load shedding parts, and adding of load adding parts, of the controlled load portions in real time behind the utility meter, thereby controlling the opted-in customers' loads in real time according to the particular grid participant rule, preferably contributes to making the intermediate circuits for the referenced controlled load customers autonomously real time adaptive to substantially conform to the particular grid participant rule.

The second method further is preferably such that certain of the controlled load customers are power generation customers, who each has an intermittent power generation system that provides unpredictably fluctuating generated power to that customer's customer circuit, further comprising: preferably detecting in real time changes in each power generation customer's varying load and unpredictably fluctuating generated power; wherein, in real time response to detected excesses in power to meet a power generation customer's varying load and desired outcome on that power generation customer's customer circuit, the controllers for that power generation customer's customer circuit preferably autonomously connect the load adding parts to preferably add sufficient load in real time to preferably absorb the excesses behind the utility meter wherein, in real time response to detected deficiencies in power to meet the power generation customer's varying load and desired outcome on that power generation customer's customer circuit, the controllers for that power generation customer's customer circuit preferably autonomously disconnect the load shedding parts to preferably shed sufficient load in real time to preferably reduce the deficiencies behind the utility meter; whereby autonomously connecting and disconnecting the load adding parts and load shedding parts behind the meter in real time according to the particular grid participant rule preferably contributes to making the power generation customers' customer circuit autonomously real time adaptive to preferably conform to the particular grid participant rule and preferably contributes to making the referenced controlled load customers' intermediate circuits autonomously real time adaptive to preferably conform to the particular grid participant rule.

The present invention is also preferably an autonomously real tune adaptive grid, comprising: a grid operably connected to a grid participant that provides power to customers through a plurality of intermediate circuits, wherein each customer has a varying load connected to a customer circuit, wherein each customer circuit is behind a utility meter that is connected at a common connection to one of the intermediate circuits, wherein certain of the customers are power generation and storage customers, who each has a power generation system linked to a storage device by a charger/inverter that charges the storage device using (optionally) power from the grid or generated power from the power generation system, or discharges stored power from the storage device, wherein the improvement comprises: energy management controllers preferably connected to controlled load portions of the varying loads of controlled load customers, to preferably control in real time the controlled load portions, preferably by autonomously connecting or disconnecting the controlled load portions from the customer circuits of the controlled load customers, whereby the controllers preferably allow autonomous load adding and load shedding in real time of the controlled load portions, and to preferably autonomously detect in real time changes in the varying load due to connection and disconnection of the controlled load portions; and energy management controllers connected to controlled charger/inverters of the power generation and storage customers, to preferably autonomously control in real time the charger/inverters to preferably autonomously direct generated power to charge the storage devices, or to preferably autonomously direct generated power or stored power to the customer circuit, to preferably provide power to the controlled power generation and storage customers' varying loads, and to preferably detect in real time unpredictably fluctuating generated power of that customer's power generation system; wherein each controller is preferably associated with each controlled load customer's and each power generation, and storage customer's corresponding intermediate circuit, and with reference criteria for each controlled load customer and for each power generation and storage customer; wherein the controllers can be preferably aggregated and segregated into subsets by the intermediate circuits and by the reference criteria; wherein each controller is preferably downloadably connected to the grid participant so that the grid participant can preferably download multiple selected grid participant rules to multiple selected subsets of the controllers; whereby by downloading a controlled load grid participant rule to a controlled load subset of the controllers, the controlled load subset of the controllers preferably autonomously manages in real time the controlled load portions to preferably allow load adding and load shedding in real time according to the controlled load grid participant rule; and whereby by preferably downloading a power generation and storage grid participant rule to a power generation and storage subset of the controllers, the power generation and storage subset of the controllers preferably autonomously manages in real time the controlled power generation systems and controlled storage devices to preferably provide power to the grid at the common connection that conforms to the grid participant's desired outcomes for customer circuits of the power generation and storage subset of the controllers.

Preferably, the power generation and storage customers are a subset of the controlled load customers, but not necessarily.

In the present inventions described above, the reference criteria are preferably selected from the group consisting of the intermediate circuit to which the referenced controlled load customer or power generation and storage customer is connected, the area in which the referenced controlled load customer or power generation and storage customer is located, the type of the referenced or power generation and storage customer's intermittent power generation system, the direction the referenced power generation and storage customer's intermittent power generation system faces, the geographic characteristics of the terrain around the referenced power generation and storage customer's intermittent power generation system, the capacity of the referenced power generation and storage customer's intermittent power generation system, the type of power usage of the controlled load customer or power generation and storage customer, whether the referenced controlled load customer has energy storage, and other criteria that may cause a subset of the controlled load customers' controlled loads or the power generation and storage customer's intermittent power generation system to behave differently from other controlled loads or intermittent power generation systems connected to the grid.

The present invention is also preferably a third method for reducing the instability of a grid operably connected to a grid participant that provides power to customers through a plurality of intermediate circuits, wherein each customer preferably has a varying load on a customer circuit that is behind a utility meter connected at a common connection to one of the intermediate circuits, wherein certain of the customers are preferably power generation and storage customers, who each has an intermittent power generation system that provides unpredictably fluctuating generated power to the customer circuit, preferably linked to a storage device by a charger/inverter that charges the storage device using generated power from the power generation system (or optionally the grid), or discharges stored power from the storage device to the customer circuit (or optionally the grid), comprising: controllably connecting energy management controllers behind the utility meter to control in real time controlled load portions of the varying loads of certain controlled load customers, and to detect in real time changes in the varying load of the controlled load customers, and to preferably control in real time the charger/inverters of controlled power generation and storage customers, and to preferably detect in real time unpredictably fluctuating generated power of the power generation and storage customer's power generation systems; wherein the controllers are preferably downloadably connected to the grid participant so that the grid participant can preferably periodically download selected grid participant rules for achieving desired outcomes for that controller's customer circuit; wherein, in real time response to detected excesses in power for meeting a customer's varying load and desired outcome on a customer circuit, the controllers for that customer circuit preferably autonomously direct the charger/inverter for that customer circuit in real time to preferably send sufficient generated power to load adding parts of the controlled load portions or to preferably charge a storage device to absorb such excess; wherein, in real time response to detected deficiencies in power for meeting a customer's varying load and desired outcome on a customer circuit, the controllers for that customer circuit preferably autonomously disconnect load shedding parts of the controlled load portions or preferably discharge stored power from the storage device to preferably make available power to meet the deficiencies; whereby the controllers preferably autonomously manage in real time the controlled load portions and the charger/inverters to preferably smooth out the power fluctuations (the excess and deficiencies) and to preferably provide power to the grid at the common connection that preferably conforms to the grid participant's desired outcome for that customer circuit.

The controlled load portions in the present inventions described above preferably comprise devices selected from the group consisting of water heaters, air conditioners, space heaters, swimming pool heaters and swimming pool pumps, and can also include energy storage devices and charger/inverters.

For the present inventions (described above) that preferably contain energy storage devices (storage devices), the power generation system, the charger/inverter and the storage device may be preferably connected to a micro grid connected circuit to preferably power at least a micro grid portion of that power generation and storage customer's varying load, wherein the micro grid connected circuit is preferably connected to the customer circuit, wherein the micro grid connected circuit is preferably connected to the customer circuit by an isolating switch (which could be located in the charger/inverter and optionally act automatically), and the controlled load is preferably connected only to the customer circuit, and not to the micro grid connected circuit, whereby opening the isolating switch preferably isolates the micro grid connected circuit from the grid and from the controlled load; wherein the energy management controller preferably monitors power from the grid and preferably opens the isolating switch when the intermediate circuit is off-line; whereby when the intermediate circuit is off line, critical loads on the micro grid connected circuit can preferably receive stored power through the charger/inverter discharged from the storage device.

The critical loads described above preferably comprise devices selected from the group consisting of refrigerators, freezers, medical equipment, lighting, and chargers (e.g. chargers for mobile devices).

The present invention is also preferably a customer circuit for a grid participant customer having a varying load behind a utility meter that is connected at a common connection to an intermediate circuit of a grid, comprising: an intermittent power generation system; a storage device; a charger/inverter linking the power generation system to the storage device that preferably charges the storage device using generated power from the power generation system or preferably discharges stored power from the storage device; energy management controllers preferably connected to (1) a controlled load portion of the varying load, to preferably autonomously control in real time the controlled load portion, by preferably autonomously connecting or disconnecting the controlled load portion from the customer circuit, whereby the controllers preferably allow adding of load adding parts, and shedding of load shedding parts, in real time, of the controlled load portion, and to preferably detect in real time changes in the varying load due to connection and disconnection of the controlled load portions; (2) the charger/inverter, to preferably control in real time the charger/inverter to preferably direct generated power to autonomously charge the storage device, or to preferably autonomously direct generated power or stored power to the customer circuit, to preferably provide power to the varying load, and to preferably detect in real time unpredictably fluctuating generated power of that customer's power generation system; wherein the controllers are preferably downloadably connected to the grid participant so that the grid participant can preferably download selected grid participant rules for achieving desired outcomes for the customer circuit; wherein, in real time response to detected excesses in power for meeting the customer's varying load and the desired outcome at the common connection, the controllers preferably autonomously direct the charger/inverter in real time to send sufficient power to the load adding parts or to preferably autonomously charge the storage device to absorb such excess; wherein, in real time response to detected deficiencies in power for meeting the customer's varying load and desired outcome at the common connection, the controllers preferably autonomously disconnect the load shedding parts of the controlled load portions or preferably autonomously discharge stored power from the storage device to preferably make available power to meet the deficiencies; whereby the controllers autonomously manage in real time the controlled load portions and the charger/inverters to smooth out the power fluctuations (the excess and deficiencies) and to preferably provide power to the grid at the common connection that preferably conforms to the grid participant's desired outcome for the customer circuit.

The incorporation of (preferably autonomous) real-time adaptive controllers into existing and future intermittent power generation systems connected (directly or indirectly) to utility grids mitigates intermittent power related instabilities, thereby allowing connections of additional intermittent power generation systems to grids where it would not otherwise be allowable.

Further, it is believed that the present invention's real time adaptiveness at the customer circuit level requires storage devices with at least fifty (50%) less storage capacity than those of stand-alone systems, thereby significantly decreasing the overall cost of these systems to customers.

### BRIEF DESCRIPTION OF DRAWINGS

FIG. 1 depicts a first presently preferred embodiment of the invention, which allows for home energy monitoring, load shedding and load adding with energy consuming devices (controlled loads), an intermittent power generation system 7 to make unpredictably fluctuating power (intermittent power), and a storage device (a battery system) 16 to store or export power. The micro grid circuit 8 can be disconnected from the customer circuit 17 to function as a micro grid when the intermediate circuit connected to the utility (or other grid participant) is off-line (i.e. when the grid is down).

FIG. 2 depicts a second presently preferred embodiment of the invention that is similar to the first embodiment, except that the micro grid circuit is created when the intermittent power generation system 7 is connected to the micro grid circuit 8 at the electric distribution box 22. Otherwise, the intermittent power generation system 7 is normally connected to the customer circuit 17.

FIG. 3 depicts a third presently preferred embodiment of the present invention which also allows for the isolation of a micro grid circuit when the intermediate circuit connected to the utility (or other grid participant) 18 is off-line (i.e. when the grid is down) to power critical loads 11 (including but not limited to refrigerators, freezers, medical equipment, lighting, chargers for mobile devices (such as phone chargers), and other critical loads). The micro grid circuit is created when the controlled load 19 and critical loads 11 are connected to the micro grid circuit 8.

FIG. 4 depicts a fourth presently preferred embodiment of the present invention which allows for home energy monitoring, load shedding and load adding with controlled loads 19, and an intermittent power generation system 7 to make electricity. This embodiment does not contain a storage device.

FIG. 5 depicts a fifth presently preferred embodiment for the present invention which allows for home energy monitoring and load shedding and load adding with controlled loads 19. This embodiment is appropriate for customers who do not have an intermittent power generation system or a storage device (battery).

FIG. 6 depicts a sixth presently preferred embodiment for the present invention which allows for only home energy monitoring. This embodiment is appropriate for customers who do not have an intermittent power generation system, storage device, or controlled loads.

### BEST MODE FOR CARRYING OUT THE INVENTION

The present invention preferably includes energy management controllers (controllers) installed behind the utility meters at residential customers' homes, or at commercial, or other customers' properties, which have intermittent power generation systems (“customers”). The controllers are preferably downloadably connected (directly or indirectly) to the utility (or other grid participant) and preferably control in real time energy producing devices, energy consuming devices, and energy storage devices (storage devices), and measure in real time power that is produced, consumed, stored, or exported to the grid by these devices. The controllers also preferably measure power on customers' circuits located behind the meter in real time.

For purposes of this disclosure, the term “real time” practically means within fifteen seconds, preferably means within 10 seconds, and optimally means within one second or less.

Each energy management controller preferably bears a unique identifier that can be associated with an intermediate circuit to which it is connected (including but not limited to its nearest transformer, neighborhood circuit, intermediate circuit, and sub-transmission station connected to the utility grid). The controllers preferably use data tags that allow the utility (or other grid participant) to associate the controllers based on reference criteria (such as the intermediate circuit to which the customer circuit is connected, the area in which the customer circuit is located, the customer's type of intermittent power generation system, the direction the customer's intermittent power generation system faces, the geographic characteristics of the terrain around the customer's intermittent power generation system, the capacity of the customer's intermittent power generation system, the type of power usage of the customer, and whether the customer has a storage device). The utility (or other grid participant) preferably aggregates or segregates pluralities of energy management controllers into unlimited desired subsets using the reference criteria and preferably creates updatable utility rules (or other grid participant rules) that are downloadable to the desired subsets of aggregated controllers connected to customer circuits, which themselves are connected to an intermediate circuit, and creates incentive or penalty programs designed to encourage customer participation in the rules to achieve the utility's desired outcome (or other grid participant's desired outcome) for the customers' circuits or aggregated desired outcomes for an intermediate circuit.

For example, the utility (or other grid participant) may create the rule that storage devices will store all or certain amounts of intermittent power to prevent export to the grid during the day, in order to achieve the utility's (or other grid participant's) desired outcome of having zero power exported to an intermediate circuit during the day. If customers having circuits connected to that intermediate circuit opt in to the rule, their controllers autonomously and in real time manage energy producing devices, energy consuming devices, and any storage devices on the customer's circuit to achieve real time adaptiveness to constant fluctuations in energy production and energy consumption on the customer's circuit to achieve the utility's for other grid participant's) desired outcome for the customer's circuit, aggregate desired outcome for the intermediate circuit to which the customer's circuit is connected, or aggregate desired outcome for the grid.

Each energy management controller preferably acts autonomously from the utility (or other grid participant) and also autonomously from other energy management controllers.

Examples of utility (or other grid participant) desired outcomes can preferably include, but not be limited to, having all of the generated power from an intermediate circuit exported to the grid, or only steady and predictable amounts of power (firm power) exported to the grid, or even no power exported to the grid, during certain times of the day and/or year.

The energy management controllers can also monitor and autonomously react to undesirable grid conditions, such as low grid frequency, low or high voltage conditions and reactive power output, among others, and act according to certain updatable utility (or other grid participant) rules to correct those conditions, by autonomously charging or discharging storage devices and/or autonomously remotely connecting or disconnecting to the customer circuit controlled loads, to achieve the utility's (or other grid participant's) desired outcomes for the customer circuit.

Once customers decide to take advantage of utility (or other grid participant) incentives and opt in to all, some or none of the utility (or other grid participant) rules, the present invention can be preferably carried out in several different ways, some of which are further illustrated by way of example in the figures.

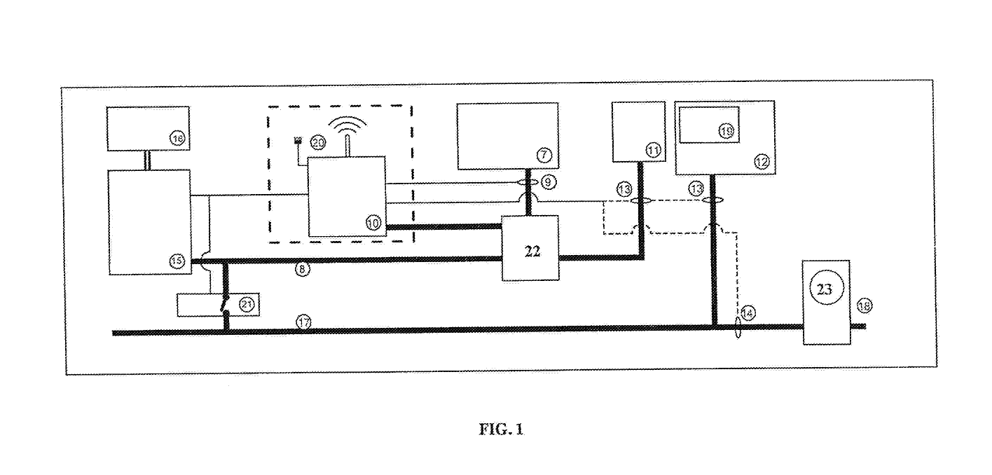

Referring to FIG. 1, shown is a first presently preferred embodiment of the invention comprising an energy producing device or intermittent power generation system 7 that delivers intermittent power to a micro grid connected circuit 8 through the electrical, distribution box 22. The energy management controller 10 preferably continually measures the intermittent power produced in real time by intermittent power generation system 7 at 9. Energy consuming devices, including critic-al loads 11 and other electric loads 12 draw unpredictable and varying amounts of power from the micro grid connected circuit 8 and customer circuit 17. The energy management controller 10 preferably continually measures power consumed in real time by the critical loads 11 and other electric loads 12 at 13, power exported or imported to and from the intermediate circuit 18 at the point of common coupling 14, and intermittent power produced by the intermittent power generation system 7 at 9, to determine actual load in real time.

In real time response to the power measured continually at 9, 13, and 14, the energy management controller 10 preferably applies in real time certain updatable utility (or other grid participant) rules to manage the power exported to the intermediate circuit 18 through the utility meter 23 by remotely connecting or disconnecting controlled loads (such as water heaters, space heaters, swimming pool pumps, air conditioners, and any other non-critical loads 19, and also including the storage device 16 and charger/inverter 15) to achieve the utility's (or other grid participant's) desired outcomes for the customer circuit 17, aggregate desired outcome for the intermediate circuit 18 connected to the customer circuit 17, or aggregate desired outcome for the grid.

The energy management controller 10 also preferably measures utility power conditions (including, voltage, frequency and power factor) at the point of common coupling 14 in real time. When the utility power conditions are outside defined parameters, the energy management controller 10 preferably acts in real time according to certain updatable utility (or other grid participant) rules to manage behind the utility meter 23 the power exported to the utility grid (through the intermediate circuit 18), by charging or discharging the storage device 16 and/or remotely connecting or disconnecting other controlled loads 19 to the customer circuit 17, to achieve the utility's (or other grid participant's) desired outcomes for the customer circuit 17.

Specifically, the energy management controller 10 preferably directs the charger/inverter 15 to either charge the storage device 16 at varying rates in real time, drawing controlled amounts of power from the micro grid connected circuit 8 and customer circuit 17, or discharge the charger/inverter 15 at varying rates in real time, delivering controlled amounts of power to the micro grid connected circuit 8 and customer circuit 17.

The charger/inverter 15 is preferably a bidirectional inverter that allows for the import and export of power to and from the storage device 16.

The energy management controller 10 also preferably remotely connects (or turns on) the controlled loads 15, 16, 19 to the customer circuit 17 in real time, thereby increasing load (load adding), or disconnects (or turns off) the controlled loads 15, 16, 19 from the customer circuit 17 in real time, thereby decreasing load (load shedding). The controlled loads 15, 16, 19 can be added or shed independently from one another. For example, the energy management controller 10 may turn on the water heater, but not the pool pump. The controlled loads 15, 16, 19 are preferably controlled using technology such as Zigbee, which is a wireless protocol that allows household devices (loads) to connect and communicate with each other. The energy management controller 10 can turn on and off controlled loads 15, 16, 19 and other loads using remotely controllable switches, such as switches that use the Zigbee protocol.

When the energy management controller 10 determines the intermediate circuit 18 is off-line (for example, if there is an electrical outage), isolating switch 21 is preferably opened, isolating the micro grid connected circuit 8 from the intermediate circuit 18, thereby creating a micro grid. The charger/inverter 15 allows the intermittent power generation system 7 to continue operating together with the storage device 16, providing power to the critical loads 11 (such as refrigerators and freezers). When the energy management controller 10 determines the intermediate circuit 18 is on-line, isolating switch 21 is preferably closed, thereby reconnecting the micro grid connected circuit 8 to the intermediate circuit 18.

This first presently preferred embodiment is appropriate for customers who want to monitor their home load over time and also take advantage of utility (or other grid participant) incentives (or avoid utility or other grid participant penalties) by allowing their energy management controller (controller) to autonomously and in real time manage energy producing devices, energy consuming devices, and storage devices on that customer's circuit to achieve real time adaptiveness to constant fluctuations in intermittent power produced, to achieve the utility's (or other grid participant's) desired outcomes for that customer circuit. Customers also have the added advantage of having emergency power for their critical loads when the intermediate circuits are off-line (i.e. the grid is down).

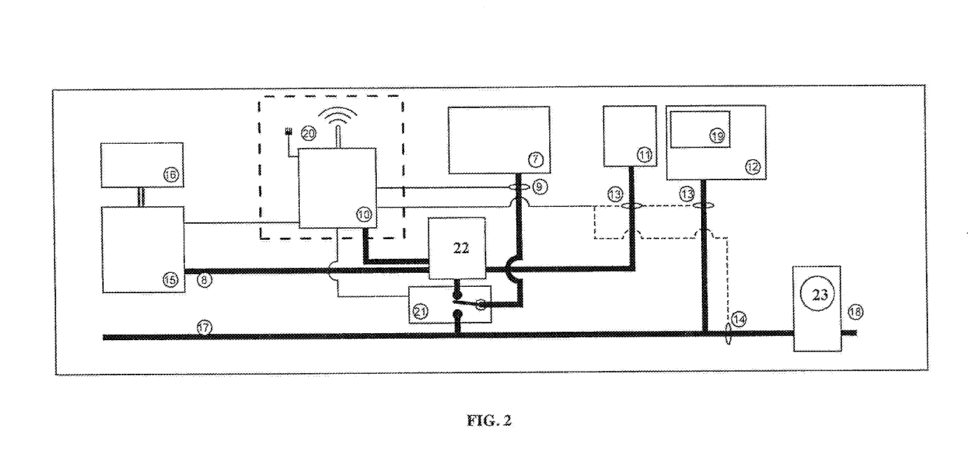

Referring to FIG. 2, shown is a second presently preferred embodiment of the invention. This embodiment functions like the first embodiment, except that the micro grid is created when the isolating switch 21 is opened and the intermittent power generation system 7 is connected to the micro grid connected circuit 8 at the electric distribution box 22. When the intermediate circuit 18 is on-line and micro grid connected circuit 8 is not necessary, isolating switch 21 is preferably closed and the intermittent power generation system 7 is connected to the customer circuit 17.

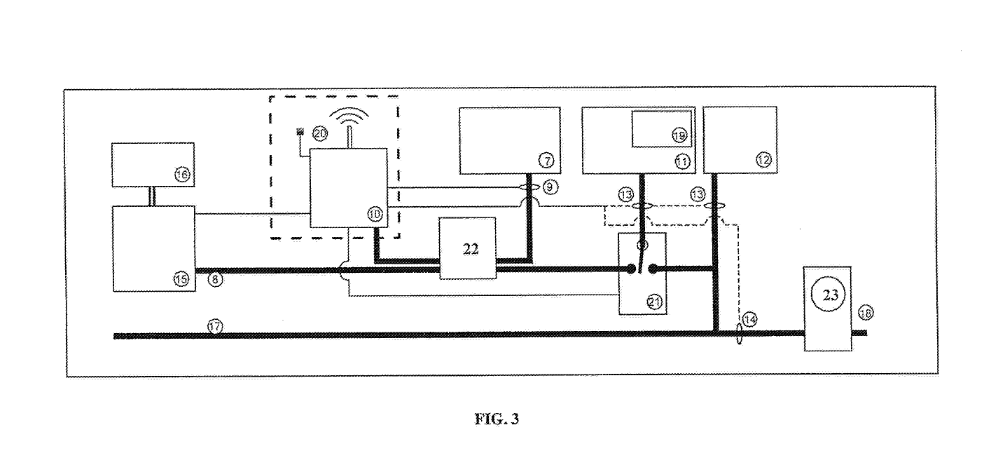

Referring to FIG. 3, shown is a third presently preferred embodiment of the invention comprising an intermittent power generation system 7 that delivers intermittent power through the electric distribution box 22 to the micro grid connected circuit 8. The energy management controller 10 continually measures power produced by the intermittent power generation system 7 at 9 in real time. Other electric loads 12 draw unpredictable and varying amounts of power from the customer circuit 17, and critical electric loads 11 draw unpredictable and varying amounts of power from the micro grid connected circuit 8 and/or the customer circuit 17. The energy management controller 10 continually measures in real time power at 13 or 14, preferably separating out the intermittent power produced by the intermittent power generation system 7 at 9 to determine actual load.

The energy management controller 10 preferably acts according to certain updatable utility (or other grid participant) rules to manage power on the micro grid connected circuit 8 by charging or discharging the storage device 16 (drawing or delivering power to or from the micro grid connected circuit 8 to the storage device 16), and/or remotely connecting or disconnecting controlled loads 15, 16, 19 and critical loads 11 to the micro grid connected circuit 8 or customer circuit 17 in real time response to the power continually measured at 9, 13, and 14 to achieve the utility's (or other grid participant's) desired outcomes at the intermediate circuit level.

For example, if the energy management controller 10 determines that there is enough power from the charger/inverter 15 and/or the intermittent power generation system 7 to power critical electric loads 11 and controlled loads 15, 16, 19, isolating switch 21 is connected in real time to the micro grid connected circuit 8 thereby creating a micro grid. When the energy management controller 10 determines there is not enough power available to power critical electric loads 11 and controlled loads 19 (including the storage device 16 and charger/inverter 15), isolating switch 21 is connected to the customer circuit 17 in real time thereby connecting the critical loads 11 and controlled loads 15, 16, 19 to the customer circuit 17 connected to the intermediate circuit 18. The other electric loads 12 receive power from the intermediate circuit 18 through the utility meter 23 and the customer circuit 17.

The energy management controller 10 also preferably directs in real time the charger/inverter 15 to store in the storage device 16 excess intermittent power produced by the intermittent power generation system 7, or to export excess power to feed the critical loads 11 and controlled loads 15, 16, 19 when they are connected to the micro grid connected circuit 8.

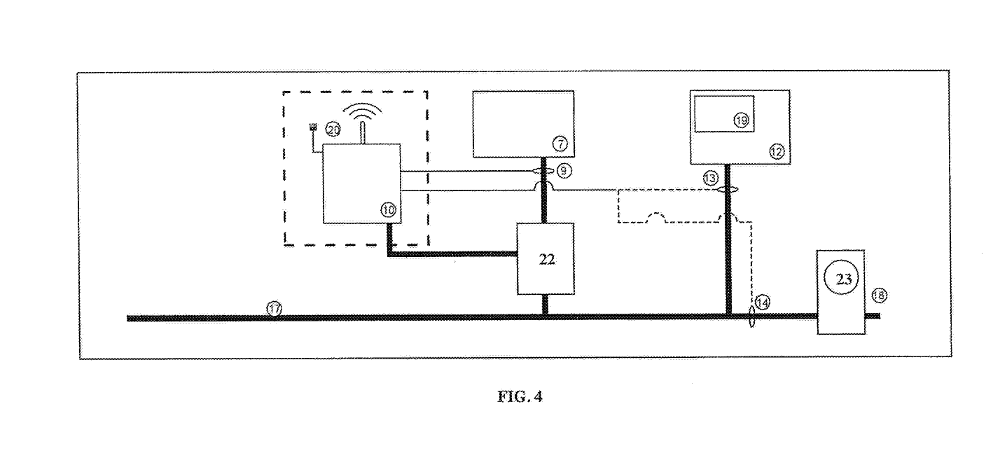

Referring to FIG. 4, shown is a fourth presently preferred embodiment of the invention. The fourth embodiment does not contain a separate micro grid connected circuit with the ability to isolate that micro grid circuit when the intermediate circuit is off-line. It also does not contain a charger/inverter or storage device.

Instead, it preferably comprises an intermittent power generation system 7 that delivers unpredictable and varying amounts of power to the customer circuit 17 and other electric loads 12 that draw unpredictable and varying amounts of power from the customer circuit 17. The controller 10 preferably continually measures power consumed by loads at 13, and power exported or imported to and from the intermediate circuit at the point of common coupling 14, separating out the intermittent power produced by the intermittent power generation system 7 at 9, to determine actual load in real time.

The energy management controller 10 preferably acts according to certain updatable utility (or other grid participant) rules to manage intermittent power from the intermittent power generation system entering the intermediate circuit 18 (connected to the grid) through the utility meter 23 by remotely connecting controlled loads 19 to the customer circuit 17, thereby increasing load, or disconnecting controlled loads 19 from customer circuit 17, thereby decreasing load, in real time response to the power continually measured at 9, 13, and 14, to achieve the utility's (or other grid participant's) desired outcomes.

The fourth presently preferred embodiment can be used by customers to monitor their home load over time and take advantage of utility (or other grid participant) incentives (and/or avoid utility or other grid participant penalties) for achieving the utility's (or other grid participant's) desired outcomes by using controlled loads at specific times of the day and/or limiting or allowing the export of renewable energy to the grid at specific times of the day.

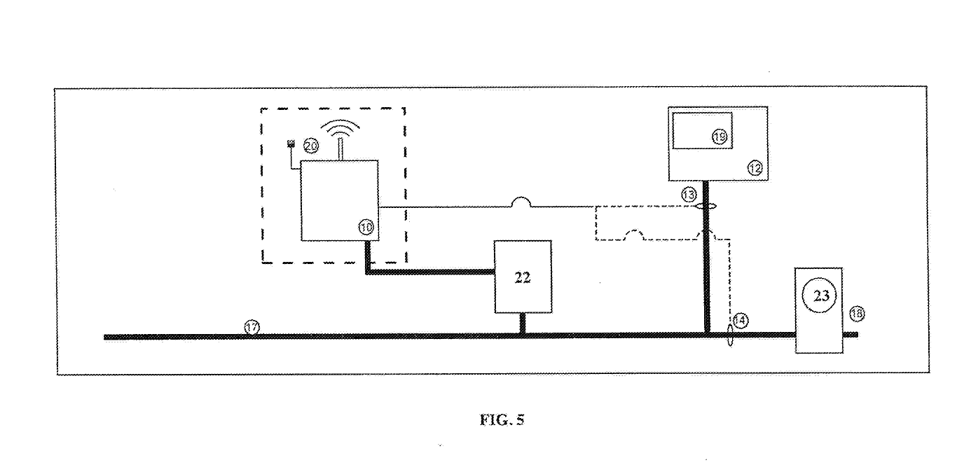

Referring to FIG. 5, shown is a fifth presently preferred embodiment of the invention. The fifth embodiment does not contain a separate micro grid connected circuit, an storage device, or an intermittent power generation system. It comprises electric loads 12 that draw unpredictable and varying amounts of power from the customer circuit 17, and an energy management controller 10 that continually measures power consumed by the electric loads at 13, or power exported or imported to and from the intermediate circuit at the point of common coupling 14 to determine actual load.

The energy management controller 10 acts according to updatable utility (or other grid participant) rules in real time in response to its measurement of actual load to manage power entering the intermediate circuit 18 by connecting controlled loads 19 to the customer circuit 17, thereby increasing load, or disconnecting them from the customer circuit 17, thereby decreasing load, to achieve the utility's (or other grid participant's) desired outcomes.

This fifth presently preferred embodiment is useful for customers who do not have intermittent power generation systems, but who nonetheless want to monitor their home load over time and also take advantage of utility (or other grid participant) incentives (and/or avoid utility or other grid participant penalties) for achieving the utility's (or other grid participant's) desired outcomes by using their controlled loads only at specific times according to the incentives or penalties.

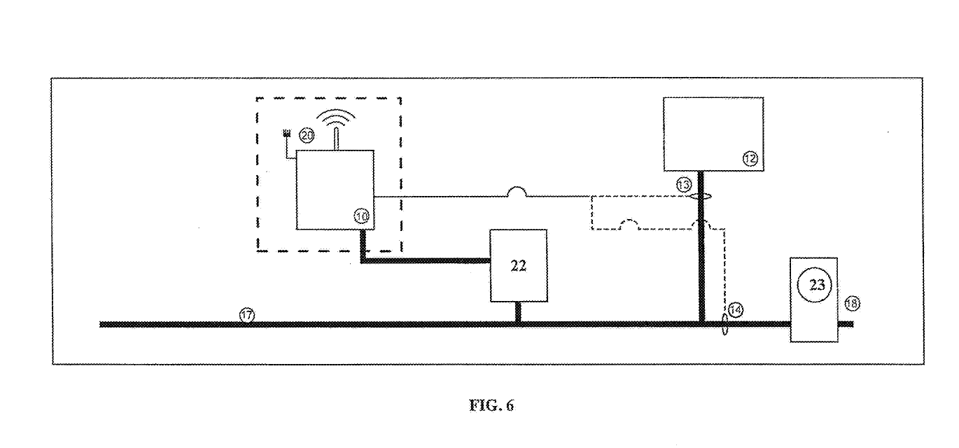

Referring to FIG. 6, shown is a sixth presently preferred embodiment of the invention. This embodiment is useful when customers do not have an intermittent power generation system, storage device or controlled loads, but nonetheless want to monitor their home load over time. It comprises only electric loads 12 drawing unpredictable and varying amounts of power from the customer circuit 17, and an energy management controller 10 that continually measures power at 13 and 14 to determine actual load.

In all the preferred embodiments, the energy management controller 10 continually records the status and activities of the energy producing devices, energy storage devices, and energy consuming devices, as well as the power on circuits, preferably continually uploading the information to the Internet 20. The information is preferably used to determine the real time adaptiveness of customers' circuits and/or customer participation in utility (or other grid participant) rules and can be accessed by the utility (or other grid participant) and the customer; however, this information is preferably aggregated and anonymized (de-identified) by an aggregator to avoid disclosing power use data (at the customer circuit level) to the utility (or other grid participant).

The utility (or other grid participant) can use the aggregated and de-identified information to accurately model various challenges to the grid, and to redesign and modify its incentive or penalty programs, as necessary, to encourage more customers to opt in to all or some of its utility (or other grid participant) rules. Customers, however, always retain the ability to elect whether to participate in the utility (or other grid participant) rules or not, based on their energy needs and habits and the associated incentives or penalties.

In all the preferred embodiments, the energy management controller preferably incorporates a small internal battery power supply, allowing it to operate even if it is not receiving power from another source (such as the micro grid connected circuit or the customer circuit).

While the present invention has been disclosed in connection with the presently preferred embodiments described herein, it should be understood that there may be other embodiments which fall within the spirit and scope of the invention as defined by the appended claims. Accordingly, no limitations are to be implied or inferred in this invention except as specifically and as explicitly set forth in the appended claims.

### INDUSTRIAL APPLICABILITY

This invention can be used whenever real time adaptiveness at the customer circuit level is desired for the management of power generated from intermittent power generation systems at residential, commercial, industrial or other properties.

What is claimed is:

1. A method for managing load on a grid operably connected to a grid participant that provides power to customers through a plurality of intermediate circuits, wherein each customer has a varying load on a customer circuit that is behind a utility meter connected at a common connection to one of the intermediate circuits, comprising:
providing energy management controllers to controlled load customers to enable each controlled load customer to controllably switch in real time controlled load portions of the varying load of that controlled load customer, by autonomously connecting or disconnecting said controlled load portions from the customer circuit of that controlled load customer in real time, whereby the controllers allow shedding of load shedding parts, and adding of load adding parts, of said controlled load portions of that controlled load customer in real time behind the utility meter;
wherein the controllers for each controlled load customer are downloadably connected to said grid participant so that said grid participant can download to the controllers grid participant rules for said grid participant's desired outcome for the intermediate circuit of that controlled load customer;
wherein certain of said controlled load customers are power generation customers, who each has an intermittent power generation system that provides unpredictably fluctuating generated power to that power generation customer's customer circuit;
detecting in real time changes in each power generation customer's varying load and unpredictably fluctuating generated power;
wherein, in real time response to detected excesses in power to meet a power generation customer's varying load and desired outcome on that power generation customer's customer circuit the controllers for that power generation customer's customer circuit autonomously connect the power generation customer's intermittent power generation system to said load adding parts to add sufficient load in real time to absorb the excesses behind the utility meter;
wherein in real time response to detected deficiencies in power to meet the power generation customer's varying load and desired outcome on that power generation customer's customer circuit, the controllers for that power generation customer's customer circuit autonomously disconnect load shedding parts to shed sufficient load in real time to reduce the deficiencies behind the utility meter;
whereby autonomously connecting and disconnecting said load adding parts and said load shedding parts behind the meter in real time according to said grid participant rules contributes to making the power generation customers' customer circuits autonomously real time adaptive to conform to said grid participant rules.

2. A method according to claim 1, wherein the controllers for each controlled load customer are associated with reference criteria for that controlled load customer, further comprising:
downloading said grid participant rules to at least a referenced subset of controllers selected by the reference criteria that can autonomously manage in real time the controlled loads of referenced controlled load customers;
wherein each of the referenced controlled load customers can individually elect whether to opt-in to a particular grid participant rule, whereby referenced controlled load customers who have decided to opt-in to said particular grid participant rule are opted-in customers for said particular grid participant rule;
whereby autonomous load shedding and load adding of said load adding parts and said load shedding parts in real time behind the utility meter controls the opted-in customers' loads in real time according to said particular grid participant rule to contribute to making the intermediate circuits for the referenced controlled load customers autonomously real time adaptive to substantially conform to said particular grid participant rule.

3. A method according to claim 1, wherein the controlled load portions of at least one controlled load customer include energy storage.

4. A method for managing load on a grid operably connected to a grid participant that provides power to customers through a plurality of intermediate circuits, wherein each customer has a varying load on a customer circuit that is behind a utility meter connected at a common connection to one of the intermediate circuits, comprising:
controllably connecting energy management controllers to controlled load portions of the varying loads of controlled load customers, to control said controlled load portions in real time, by autonomously connecting or disconnecting said controlled load portions from the customer circuits of the controlled load customers in real time, whereby the controllers allow autonomous shedding of load shedding parts, and adding of load adding parts of said controlled load portions in real time behind the utility meter;
wherein the controllers are associated with reference criteria for each controlled load customer;
wherein the controllers are downloadably connected to said grid participant so that said grid participant can download grid participant rules to the controllers;
downloading the utility rules to at least a referenced subset of controllers selected by the reference criteria that can autonomously manage in real time the controlled loads of referenced controlled load customers;
wherein each of the referenced controlled load customers can individually elect whether to opt-in to a particular grid participant rule, whereby referenced controlled load customers who have decided to opt-in to said particular grid participant rule are opted-in customers for said particular grid participant rule;
whereby autonomous load shedding and load adding of the controlled load portions in real time behind the utility meter controlling the opted-in customers' loads in real time according to said particular grid participant rule contributes to making the intermediate circuits for the referenced controlled load customers autonomously real time adaptive to substantially conform to said particular grid participant rule.

5. A method according to claim 4, wherein certain of the controlled load customers are power generation customers, who each has an intermittent power generation system that provides unpredictably fluctuating generated power to that customer's customer circuit, further comprising:
detecting in real time changes in each power generation customer's varying load and unpredictably fluctuating generated power;
wherein, in real time response to detected excesses in power to meet a power generation customer's varying load and desired outcome on that power generation customer's customer circuit, the controllers for that power generation customer's customer circuit autonomously connect said load adding parts to add sufficient in real time to absorb the excesses behind the utility meter;
wherein in real time response to detected deficiencies in power to meet the power generation customer's varying load and desired outcome on that power generation customer's customer circuit, the controllers for that power generation customer's customer circuit autonomously disconnect said load shedding parts to shed sufficient load in real time to reduce the deficiencies behind the utility meter;
whereby autonomously connecting and disconnecting said load adding parts and said load shedding parts behind the meter in real time according to said particular grid participant rule contributes to making the power generation customers' customer circuit autonomously real time adaptive to conform to said particular grid participant rule and contributes to making the referenced controlled load customers' intermediate circuits autonomously real time adaptive to conform to said particular grid participant rule.

6. An autonomously real time adaptive grid, comprising:
a grid operably connected to a grid participant that provides power to customers through a plurality of intermediate circuits, wherein each customer has a varying load connected to a customer circuit, wherein each customer circuit is behind a utility meter that is connected at a common connection to one of said intermediate circuits, wherein certain of said customers are power generation and storage customers, who each has a power generation system linked to a storage device by a charger/inverter that charges said storage device using generated power from said power generation system or discharges stored power from said storage device,
wherein the improvement comprises:
energy management controllers connected to
controlled load portions of said varying loads of controlled load customers, to control in real time said controlled load portions, by autonomously connecting or disconnecting said controlled load portions from said customer circuits of said controlled load customers, whereby said controllers allow autonomous load adding and load shedding in real time of said controlled load portions, and to detect in real time changes in said varying load due to connection and disconnection of said controlled load portions;
controlled charger/inverters of said power generation and storage customers, to control in real time said charger/inverters to autonomously direct generated power to charge said storage devices, or to autonomously direct generated power or stored power to said customer circuit, to autonomously provide power to said controlled power generation and storage customers' varying loads, and to detect in real time unpredictably fluctuating generated power of that customer's power generation system;
wherein each controller is associated with each controlled load customer's and each controlled power generation and storage customer's corresponding intermediate circuit, and with reference criteria for each said controlled load customer and for each said controlled power generation and storage customer;
wherein said controllers can be aggregated and segregated into subsets by said intermediate circuits and by said reference criteria;
wherein each controller is downloadably connected to said grid participant so that said grid participant can download multiple selected grid participant rules to multiple selected subsets of said controllers;
whereby by downloading a controlled load grid participant rule to a controlled load subset of said controllers, said controlled load subset of said controllers autonomously manages in real time said controlled load portions to allow load adding and load shedding in real time according to said controlled load grid participant rule; and
whereby by downloading a power generation and storage grid participant rule to a power generation and storage subset of said controllers, said power generation and storage subset of said controllers autonomously manages in real time said controlled power generation systems and controlled storage devices to provide power to said grid at said common connection that conforms to said grid participant's desired outcomes for customer circuits of said power generation and storage subset of said controllers.

7. An adaptive grid according to claim 6, wherein the reference criteria is selected from the group consisting of the intermediate circuit to which the referenced controlled load customer is connected, the area in which the referenced controlled load customer is located, the type of the referenced controlled load customer's intermittent power generation system, the direction the referenced controlled load customer's intermittent power generation system faces, the geographic characteristics of the terrain around the referenced controlled load customer's intermittent power generation system, the capacity of the referenced controlled load customer's intermittent power generation system, the type of power usage of the controlled load customer, and whether the referenced controlled load customer has energy storage.

8. A method according to any one of claim 2, or 4, wherein the reference criteria is selected from the group consisting of the intermediate circuit to which the referenced controlled load customer is connected, the area in which the referenced controlled load customer is located, the type of the referenced controlled load customer's intermittent power generation system, the direction the referenced controlled load customer's intermittent power generation system faces, the geographic characteristics of the terrain around the referenced controlled load customer's intermittent power generation system, the capacity of the referenced controlled load customer's intermittent power generation system, the type of power usage of the controlled load customer, and whether the referenced controlled load customer has energy storage.

9. A method for reducing instability of a grid operably connected to a grid participant that provides power to customers through a plurality of intermediate circuits, wherein each customer has a varying load on a customer circuit that is behind a utility meter connected at a common connection to one of said intermediate circuits, wherein certain of said customers are power generation and storage customers, who each has an intermittent power generation system that provides unpredictably fluctuating generated power to said customer circuit, linked to a storage device by a charger/inverter that charges said storage device using generated power from said power generation system, or discharges stored power from said storage device to said customer circuit, comprising:
controllably connecting energy management controllers behind said utility meter
to autonomously control in real time controlled load portions of said varying loads of certain controlled load customers, and to detect in real time changes in said varying load of said controlled load customers, and
to autonomously control in real time said charger/inverters of controlled power generation and storage customers, and to detect in real time unpredictably fluctuating generated power of said power generation and storage customer's power generation systems;
wherein the controllers are downloadably connected to said grid participant so that said grid participant can periodically download selected grid participant rules for achieving desired outcomes for that controller's customer circuit;
wherein, in real time response to detected excesses in power for meeting a customer's varying load anti desired outcome on a customer circuit, the controllers for that customer circuit autonomously direct the charger/inverter for that customer circuit in real time to send sufficient generated power to said controlled load portions or to charge a storage device to absorb such excess;
wherein, in real time response to detected deficiencies in power for meeting a customer's varying load and desired outcome on a customer circuit, the controllers for that customer circuit autonomously disconnect said controlled load portions or discharge stored power from said storage device to provide power to meet said deficiencies;
whereby said controllers autonomously manage in real time said controlled load portions and said charger/inverters to smooth out said excess and said deficiencies and to provide power to said grid at said common connection that conforms to said grid participant's desired outcome for that customer circuit.

10. An adaptive grid according to claim 6, wherein said controlled load portions comprise devices selected from the group consisting of water heaters, air conditioners, space heaters, swimming pool heaters and swimming pool pumps.

11. A method according to any one of claim 1, 2, 3, 4, 5, or 9, wherein said controlled load portions comprise devices selected from the group consisting of water heaters, air conditioners, space heaters, swimming pool heaters and swimming pool pumps.

12. An adaptive grid according to claim 6, wherein said power generation system, said charger/inverter and said storage device are connected to a micro grid connected circuit to power at least a micro grid portion of that power generation and storage customer's varying load, wherein said micro grid connected circuit is connected to said customer circuit,
wherein said micro grid connected circuit is connected to said customer circuit by an isolating switch, and said controlled load is connected only to said customer circuit, and not to said micro grid connected circuit, whereby opening said isolating switch isolates said micro grid connected circuit from said grid participant and from said controlled load;
wherein said energy management controller monitors power from said grid and opens said isolating switch when said intermediate circuit is off-line;
whereby when said intermediate circuit is off-line, critical loads on said micro grid connected circuit can receive stored power through said charger/inverter discharged from said storage device.

13. A method according to claim 9, wherein said power generation system, said charger/inverter and said storage device are connected to a micro grid connected circuit to power at least a micro grid portion of that power generation and storage customer's varying load, wherein said micro grid connected circuit is connected to said customer circuit,
wherein said micro grid connected circuit is connected to said customer circuit by an isolating switch, and said controlled load is connected only to said customer circuit, and not to said micro grid connected circuit, whereby opening said isolating switch isolates said micro grid connected circuit from said grid participant and from said controlled load;
wherein said energy management controller monitors power from said grid and opens said isolating switch when said intermediate circuit is off-line;
whereby when said intermediate circuit is off-line, critical loads on said micro grid connected circuit can receive stored power through said charger/inverter discharged from said storage device.

14. An adaptive grid according to claim 12, wherein said critical loads comprise devices selected from the group consisting of refrigerators, freezers, medical equipment, lighting, and chargers.

15. A method according to claim 13, wherein said critical loads comprise devices selected from the group consisting of refrigerators, freezers, medical equipment, lighting, and chargers.

16. A customer circuit for a grid participant customer having a varying load behind a utility meter at is connected at a common connection to an intermediate circuit of a grid, comprising:
an intermittent power generation system;
a storage device;
a charger/inverter linking said power generation system to said storage device that charges said storage device using generated power from said power generation system or discharges stored power from said storage device;
energy management controllers connected to
a controlled load portion of said varying load, to control in real time said controlled load portion, by autonomously connecting or disconnecting said controlled load portion from said customer circuit, whereby said controllers allow load adding and load shedding in real time of said controlled load portion, and to detect in real time changes in said varying load due to connection and disconnection of said controlled load portions;
said charger/inverter, to control in real time said charger/inverter to direct generated power to autonomously charge said storage device, or to autonomously direct generated power or stored power to said customer circuit, to provide power to said varying load, and to detect in real time unpredictably fluctuating generated power of that customer's power generation system;
wherein said controllers are downloadably connected to said grid participant so that said grid participant can download selected grid participant rules for achieving grid participant desired outcomes for said customer circuit;
wherein, in real time response to detected excesses in power for meeting said customer's varying load and said desired outcomes at said common connection, said controllers direct the charger/inverter in real time to send sufficient power to said controlled load portions or to charge said storage device to absorb such excess;
wherein in real time response to detected deficiencies in power for meeting said customer's varying load and desired outcome at said common connection, said controllers disconnect said controlled load portions or discharge stored power from said storage device to provide power to meet said deficiencies;
whereby said controllers autonomously manage in real time said controlled load portions and said charger/inverters to smooth out said excess and said deficiencies and to provide power to said grid at said common connection that conforms to said grid participant's desired outcome for said customer circuit.

17. A method according to any one of claim 1, 2, 4, 5, or 9, wherein real time is within fifteen seconds.

18. A method according to any one of claim 1, 2, 4, 5, or 9, wherein real time is within ten seconds.

19. A method according to any one of claim 1, 2, 4, 5, or 9, wherein real time is not more than one second.

20. An adaptive grid according to claim 6, wherein real time is within fifteen seconds.

21. A customer circuit according to claim 16, wherein real time is within fifteen seconds.

22. An adaptive grid according to claim 6, wherein real time is within ten seconds.

23. A customer circuit according to claim 16, wherein real time is within ten seconds.

24. An adaptive grid according to claim 6, wherein real time is not more than one second.

25. A customer circuit according to claim 16, wherein real time is not more than one second.

26. A method according to any one of claim 1, 4, or 9, wherein said energy management controllers are implemented as software on a computer.

27. An adaptive grid according to claim 6, wherein said energy management controllers are implemented as software on a computer.

28. A customer circuit according to claim 16, wherein said energy management controllers are implemented as software on a computer.

29. A method according to any one of claim 1, 4, or 9, wherein said energy management controllers can accept and act according to grid participant rules that require centralized control by the energy grid participant at times defined by said grid participant.

30. An adaptive grid according to claim 6, wherein said energy management controllers can accept and act according to grid participant rules that require centralized control by the energy grid participant at times defined by said grid participant.

31. A customer circuit according to claim 16, wherein said energy management controllers can accept and act according to grid participant rules that require centralized control by the energy grid participant at times defined by said grid participant.

32. A method for managing load on a grid operably connected to a grid participant that provides power to customers through a plurality of intermediate circuits, wherein each customer has a varying load on a customer circuit that is behind a utility meter connected at a common connection to one of the intermediate circuits, comprising:
providing an energy management controller to controlled load customers to enable each controlled load customer to controllably switch in real time controlled load portions of the varying load of that controlled load customer, by autonomously connecting load adding parts, or disconnecting load shedding parts, of said controlled load portions from the customer circuit of that controlled load customer in real time, whereby the controller allows load shedding and load adding of said controlled load portions in real time behind the utility meter;
wherein the controller for each controlled load customer is downloadably connected to said grid participant so that said grid participant can download to the controller grid participant rules for said grid participant's desired outcome for the intermediate circuit of that controlled load customer;
wherein certain of said controlled load customers are power generation customers, who each has an intermittent power generation system that provides unpredictably fluctuating generated power to that power generation customer's customer circuit;
detecting in real time changes in each power generation customer's varying load and unpredictably fluctuating generated power;
wherein, in real time response to detected excesses in power to meet a power generation customer's varying load and desired outcome on that power generation customer's customer circuit, the controller for that power generation customer's customer circuit autonomously connects the power generation customer's intermittent power generation system to said load adding parts to add sufficient load in real time to absorb the excesses behind the utility meter;
wherein in real time response to detected deficiencies in power to meet the power generation customer's varying load and desired outcome on that power generation customer's customer circuit, the controller for that power generation customer's customer circuit autonomously disconnects said load shedding parts to shed sufficient load in real time to reduce the deficiencies behind the utility meter;
whereby autonomously connecting and disconnecting said load adding parts and said load shedding parts behind the meter in real time according to said grid participant rules contributes to making the power generation customers' customer circuits autonomously real time adaptive to conform to said grid participant rules.

33. A customer circuit for a grid participant customer having a varying load behind a utility meter that is connected at a common connection to an intermediate circuit of a grid, comprising:
an intermittent power generation system;
a storage device;
a charger/inverter linking said power generation system to said storage device that charges said storage device using generated power from said power generation system or discharges stored power from said storage device;
an energy management controller connected to
a controlled load portion of said varying load, to control in real time said controlled load portion, by autonomously connecting or disconnecting said controlled load portion from said customer circuit, whereby said controller allows load adding and load shedding in real time of said controlled load portion, and to detect in real time changes in said varying load due to connection and disconnection of said controlled load portions;
said charger/inverter, to control in real time said charger/inverter to direct generated power to autonomously charge said storage device, or to autonomously direct generated power or stored power to said customer circuit, to provide power to said varying load, and to detect in real time unpredictably fluctuating generated power of that customer's power generation system;
wherein said controller is downloadably connected to said grid participant so that said grid participant can download selected grid participant rules for achieving grid participant desired outcomes for said customer circuit;
wherein, in real time response to detected excesses in power for meeting said customer's varying load and said desired outcomes at said common connection, said controller directs the charger/inverter in real time to send sufficient power to said controlled load portions or to charge said storage device to absorb such excess;
wherein in real time response to detected deficiencies in power for meeting said customer's varying load and desired outcome at said common connection, said controller disconnects said controlled load portions or discharges stored power from said storage device to provide power to meet said deficiencies;
whereby said controller autonomously manage in real time said controlled load portions and said charger/inverters to smooth out said excess and said deficiencies and to provide power to said grid at said common connection that conforms to said grid participant's desired outcome for said customer circuit.
